(19) United States
(12) Patent Application Publication
(10) Pub. No.: US 2026/0340424 A1
(43) Pub. Date: Oct. 29, 2026

(54) TOOL PLANNING USING LOOK AHEAD TREE SEARCH

(71) Applicant: GDM Holding LLC, Mountain View, CA (US)

(72) Inventors: Victor Carbune, Zürich (CH); Lei Shu, Mountlake Terrace, WA (US); Hassan Mansoor, London (GB); Jindong Chen, Hillsborough, CA (US); Ameesh Makadia, New York, NY (US); Yun Zhu, Jersey City, NJ (US); Liangchen Luo, Kitchener (CA); Srinivas Kumar Sunkara, San Jose, CA (US); Maria Wang, Sunnyvale, CA (US); Yinxiao Liu, Palo Alto, CA (US); Lei Meng, Mountain View, CA (US)

(21) Appl. No.: 19/190,482

(22) Filed: Apr. 25, 2025

(51) Int. Cl. G06N 5/01

(52) U.S. Cl. CPC G06N 5/01

(57) ABSTRACT

Methods, systems, and apparatus, including computer programs encoded on computer storage media, for performing a task. One of the methods includes: receiving a request to perform the task; performing a look ahead tree search to generate a selected path through a tree that comprises a plurality of nodes each representing a function call to a tool, wherein the selected path comprises a subset of the plurality of nodes arranged in an order along the selected path; and performing the task to generate a final result based on executing function calls to respective tools represented by the subset of the plurality of nodes in accordance with the order of the subset of the plurality of nodes along the selected path.

### BACKGROUND

This specification relates to performing tasks using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a task execution system implemented as computer programs on one or more computers in one or more locations that performs a task using a plurality of tools. The task can be any of a wide variety of tasks. The plurality of tools can include one or more generative neural networks and one or more external tools.

The task execution system performs a look ahead tree search to generate a plan, and then performs the task in accordance with the plan. The plan specifies a sequence of two or more function calls that should be executed by the task execution system in order to perform the task. For example, the sequence of the two or more function calls can include a first function call to a tool selected from among the plurality of tools, followed by a second function call to either the same tool, or a different tool selected from among the plurality of tools.

According to an aspect, there is provided a method for performing a task, the method comprising: receiving a request to perform the task; performing a look ahead tree search to generate a selected path through a tree that comprises a plurality of nodes each representing a function call to a tool, wherein the selected path may comprise a subset of the plurality of nodes arranged in an order along the selected path; and performing the task to generate a final result based on executing function calls to respective tools represented by the subset of the plurality of nodes in accordance with the order of the subset of the plurality of nodes along the selected path.

Each node in the plurality of nodes may represent a function call to one of: a generative neural network or an external tool.

Performing the look ahead tree search to generate the selected path through the tree may comprise: performing the look ahead tree search to generate a plurality of paths through the tree, wherein each path begins with a same root node of the tree and ends with a different leaf node of the tree; and selecting, as the selected path, one of the plurality of paths.

Each node in the plurality of nodes may be associated with a success rate of a function call to a tool represented by the node when executed to perform the task, and wherein selecting, as the selected path, one of the plurality of paths may comprise: selecting one of the plurality of paths based on success rates associated with the plurality of tools.

For each node in the plurality of nodes, the success rate associated with the node may be determined based on a ratio of (i) a total count of times a candidate final result is generated when the function call to the tool represented by the node is executed to perform the task during the look ahead tree search to (ii) a total count of times the node is selected during the look ahead tree search.

Performing the look ahead tree search may comprise evaluating leaf nodes of the tree encountered during the look ahead tree search using a neural network.

Evaluating leaf nodes of the tree encountered during the look ahead tree search may comprise: determining, using the neural network, whether an output generated as a return to a function call represented by a leaf node is the final result.

The method may further comprise, in response to determining that the output generated as the return to the function call represented by the leaf node is the final result: updating success rates associated with nodes included along a same path as the leaf node to have greater values.

The method may further comprise, in response to determining that the output generated as the return to the function call represented by the leaf node is not the final result: determining, using the generative neural network, whether another output can be generated based on the output generated as the return to the function call represented by the leaf node.

The method may further comprise, in response to determining that the output generated as the return to the function call represented by the leaf node is not the final result, and that another output can be generated based on the output: adding, to the tree, one or more child nodes that are each connected to the leaf node by an edge, wherein each child node represents another function call to a tool to be executed after the function call represented by the leaf tool.

The method may further comprise in response to determining that the output generated as the return to the function call represented by the leaf node is not the final result, and that another output cannot be generated based on the output: updating success rates associated with nodes arranged along a same path as the leaf node to have smaller values.

Performing the look ahead tree search may comprise, for a parent node of the tree encountered during the look ahead tree search: selecting, from among a plurality of child nodes of the parent node, a selected child node to be included along a same path as the parent node using the neural network.

Performing the look ahead tree search may comprise, for a parent node of the tree encountered during the look ahead tree search: selecting, from among a plurality of child nodes of the parent node, a selected child node to be included along a same path as the parent node based on success rates associated with the nodes.

The task may comprise a multi-modal task, and wherein the generative neural network may comprise a multi-modal generative neural network.

The multi-modal task may comprise a visual question answering task.

According to another aspect, there is provided one or more computer-readable storage media encoded with instructions that, when executed by one or more computers, cause the one or more computers to perform the operations of the above method aspect.

According to another aspect, there is provided a system comprising one or more computers and one or more storage devices storing instructions that when executed by one or more computers cause the one or more computers to perform the respective operations of the above method aspect.

It will be appreciated that features described in the context of one aspect may be combined with features described in the context of another aspect.

Particular embodiments of the subject matter described in this specification can be implemented so as to realize one or more of the following advantages.

Tool calling allows a task execution system to interact with external tools during task performance. This means the task execution system can access information beyond its own knowledge base. However, when a space of possible combinations of function calls is too large to be exhaustively searched, many existing task execution systems may not effectively determine which ones of the tools to call, as well as when to call the tools, and therefore may not achieve a desired task performance.

The described techniques enable a plan for a task to be generated automatically and with no human involvement or external supervision by performing a look ahead tree search through the space of possible combinations of function calls to one or more of a plurality of tools. The plan specifies a sequence of two or more function calls that should be executed by the task execution system to perform the task. In this way, the described techniques allow for a smaller set of tools to be effectively selected from among the plurality of tools and utilized by way of function calls, to maximize the likelihood that a high-quality result will be achieved. By executing the sequence of two or more function calls in accordance with the order specified by the plan, the task execution system can generate a result for the task that has an improved quality (e.g., improved accuracy, improved timeliness, improved comprehensiveness, and so on) relative to alternative systems that rely on predetermined fixed tool selection logic or a manual tool selection process.

The described techniques are scalable. For example, they can generate a plan that has an arbitrary length, e.g., that includes a very large number of (e.g., tens or hundreds of) function calls when performing the task. The scalability of the described techniques is particularly advantageous when performing complex, multi-step reasoning tasks that require executing a large number of function calls, generating a large number of intermediate results before arriving at the final result, or both. Thus, for example, by using the described techniques, the task execution system can exceed the state-of-the-art on arithmetic and logical reasoning tasks, visual question answering tasks, and automated assistance tasks.

Moreover, the described techniques are holistic. For example, they can generate a plan for a task that balances between different (and possibly conflicting) goals with respect to task execution, e.g., a plan that increases the completeness of a result for a visual question answering task and simultaneously reduces the amount of computational resources (e.g., memory, processor cycles, and network bandwidth) consumed by the task execution system while executing the plan to generate the result. Thus, for example, by using the described techniques, the task execution system can perform tasks in response to requests even when implemented in an environment with constrained computational resources.

Furthermore, the described techniques are adaptive. For example, they can update the plan in real-time to account for changes to the availability or performance of the tools, e.g., update the plan to include function calls to one or more new tools that are recently made available, or update the plan to exclude function calls to one or more tools that are currently experiencing downtime or interruption, or that are currently having reduced performance.

The adaptability of the described techniques is particularly advantageous in cases where the tools are hosted in distinct locations and are physically separate from each other, and thus have varying degrees of availability, latency, throughput, and so on. Implementations of the described planning techniques allow a task execution system to be adapted to overcome the geographic constraints associated with the external tools, e.g., by dynamically adjusting the plan to account for the varying degrees of availability, latency, throughput, and so on of the external tools, while still achieving a desired task performance.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example task execution system.

FIG. 2 is a flow diagram of an example process for performing a task using a plurality of tools.

FIG. 3 is a flow diagram of an example process for performing a planning iteration.

FIGS. 4A-C show example illustrations of a tree.

Like reference numbers and designations in the various drawings indicate like elements.

### DETAILED DESCRIPTION

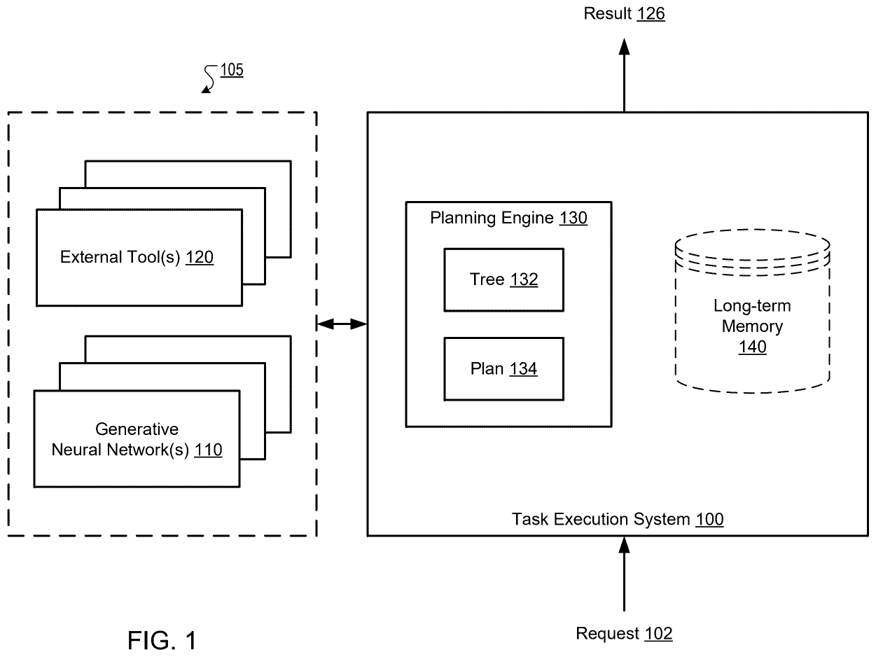

FIG. 1 is a diagram of an example task execution system 100. The task execution system 100 is an example of a system implemented as computer programs on one or more computers in one or more locations that can perform tasks and then output the results 126 for the tasks.

To perform each task, the task execution system 100 obtains instruction data that characterizes the task to be performed by the system and task data that will be processed by the system in order to perform the task. Collectively, such data will be referred to in this specification as “request data,” or “request 102” for short.

Merely as an example, the task may be a visual question answering task, and the request 102 for the task may include one or more images, e.g., an image of a manufactured part, and a text question about the one or more images, e.g., “Are there any cracks or scratches on this part?” and the output sequence may be an answer to the text question, e.g., “No, there're no cracks or scratches.” In this example, the task data includes the one or more images, and the instruction data includes the text question.

The request 102 can include data in any of a variety of modalities, e.g., any of text, audio, images, videos, or other sensor measurements, e.g., Lidar data, EEG data, EKG data, and so on. Moreover, the request 102 can be obtained in any of a variety of ways.

In some cases, the instruction data can be generated automatically, e.g., by an automated assistant or some other software applications that execute on a client device. In some other cases, the task execution system 100 can receive the instruction data as a user input. The user input can include a touchscreen input, a voice input, a keyboard input, a gesture input, a mouse, trackpad, or other pointing device input, that characterizes the task to be performed. For example, the instruction data can be in the form of a prompt, an instruction, or a command that is in some natural language and that defines the task to be performed by the system.

In some cases, the task execution system 100 can receive the task data in association with the instruction data. For example, the task data can also be received by the system together with the instruction data in a single user input or multiple user inputs. As another example, the task data can be generated automatically, e.g., by an automated assistant or another system.

In some other cases, unlike the instruction data, the task data can include prestored data, and the task execution system 100 can obtain the task data from a storage device that is accessible by the system.

In yet other cases, the task execution system 100 can obtain the task data from another system over a data communication network, e.g., through an application programming interface (API) that is made available by the other system. For example, the other system can be a sensor system (when the task is an agent control task); or a webpage capturing system, a screen recording system, or a screenshot capturing system (when the task is an automated assistance task).

In general the task execution system 100 can be configured to perform any of a variety of tasks. A few examples of the tasks follow.

In some cases, the task can be a text generation task, and the task execution system 100 can be configured to perform the text generation task by generating text sequences. In these cases, the result 126 generated by the task execution system 100 can include an output sequence of text. The result 126 can be presented for display to users on a display device, e.g., to the user who submitted the instruction data, task data, or both.

As some general examples, the text generation task can be a natural language processing or understanding task, e.g., an entailment task, a paraphrase task, a textual similarity task, a sentiment task, a sentence completion task, a grammaticality task, and so on, that operates on a request 102 that includes an input sequence of text in some natural language to generate an output sequence of text that is similarly in some natural language.

As an example, the task execution system 100 can be part of a dialog system and the request 102 can include audio or text or image data or some combination from the most recent conversational turn submitted by a user of the dialog system during the dialog, while the result 126 includes an output sequence that is the next turn in the conversation, e.g., either text or audio that is a response to the most recent conversational turn. Optionally, the request can also include one or more historical conversational turns that occurred earlier in the conversation.

As another example, the task execution system 100 can be configured to perform a machine translation task, e.g., it can be part of a machine translation system, where the request 102 can include text in a source language while the result 126 includes an output sequence of text in a target language that is a translation of the source text into the target language.

As another particular example, the task execution system 100 can be configured to perform a computer code generation task, e.g., it can be part of a computer code generation system, where the request 102 can include a text description of a desired piece of code or a snippet of computer code in a programming language and the result 126 includes computer code, e.g., a snippet of code that is described by the request or a snippet of code that follows the request in a computer program.

As another example, the task execution system 100 can be part of a search system that facilitate searching of resources on the Internet. A resource can be any data that can be provided over the Internet. A resource can be identified by a resource address that is associated with the resource. Resources include web pages, word processing documents, portable document format (PDF) documents, images, video, and news feed sources, to name a few.

In this example, the search system can receive search queries submitted by client devices and, in response, identify resources that are relevant to the search query in the form of search results and returns the search results to the user devices in search results pages. A search result page can include search result data generated by the search system that identifies a resource responsive to a search query, and includes a link to the resource. The search result page can additionally include a result 126 in the form of an output sequence of text that is generated by the task execution system 100 based on a request 102 derived from the search query.

In some cases, the task can be a multi-modal machine learning task. A multi-modal machine learning task is a task that requires a machine learning system to process an input that includes data from two or more modalities in order to generate the output for the task.

As an example, the task can be a visual question answering task, where the request 102 can include a visual input (e.g., an image or a video) and text that represents a question poised about the visual input, while the result 126 includes text that represents an answer to the question that is posed about the visual input.

As another example, the task can be an open-vocabulary image classification task, where the task execution system 100 is configured to receive a request 102 including an image and a natural language sequence for the image, which may be a sequence of words in a target natural language that describes the image, and to process the request 102 to generate a result 126 that specifies whether the natural language sequence includes an accurate description for the image.

As another example, the task can be an open-vocabulary object detection task, where the task execution system 100 is configured to receive a request 102 including an image and text describing a set of object categories, and to process the request 102 to generate a result 126 that includes a respective score for each of the set of object categories representing an estimated likelihood that the image contains an image of an object belonging to the category.

In some cases, the task can be an image or video generation task, and the task execution system 100 can be configured to perform the image or video generation task by generating images or videos that have multiple frames (where each frame is an image) as sequences of pixels. For example, the result 126 can include a plurality of color values for pixels in an image arranged according to a specified order. For example, the task execution system 100 can generate an image or a video conditioned on the request 102 that includes a text description of the content of the image or the video.

In some cases, the task execution system 100 can be configured to perform an agent control task. In these cases, the request 102 can include (i) a text sequence in a natural language that characterizes a task to be performed by an agent in the environment and (ii) one or more observations or other data respective states of the environment, and the result 126 can be any data that indicates that the agent has successfully completed the task or that some termination criterion is satisfied, e.g., the environment enters a state that has been designated as a terminal state or a threshold amount of time has elapsed without successfully completing the task.

For example, the result 126 can include a textual indicator, e.g., in the form of an output sequence of text, an audio indicator, e.g., in the form of a verbal response, or some other visual (e.g., graphical) indicator that is a confirmation of task accomplishment. As another example, the result 126 can include an observation of the environment that it is in the designated terminal state.

The agent can be, e.g., a real-world or simulated robot, a control system for an industrial facility, or a control system that controls a different kind of agent. The observations may include sensor data captured by sensors associated with (e.g. part of) the agent, for example visual data, LIDAR data, sonar data, agent configuration data (e.g. joint angles), agent orientation data, or the like. For example, the observations may include images captured by a visual sensor of the agent or by a visual sensor located in the environment.

In some cases, the environment is a real-world environment and the agent is a mechanical agent interacting with the real-world environment. For example, the agent may be a robot interacting with the environment to accomplish a task, e.g., to locate an object of interest in the environment, to move an object of interest to a specified location in the environment, to physically manipulate an object of interest in the environment in a specified way, or to navigate to a specified destination in the environment; or the agent may be an autonomous or semi-autonomous land, air, or sea vehicle navigating through the environment to a specified destination in the environment.

In some cases, the environment is a simulated environment and the agent is implemented as one or more computer programs interacting with the simulated environment. For example, the environment can be a computer simulation of a real-world environment and the agent can be a simulated mechanical agent navigating through the computer simulation. For example, the simulated environment may be a motion simulation environment, e.g., a driving simulation or a flight simulation, and the agent may be a simulated vehicle navigating through the motion simulation.

In some cases, the environment is a suitable execution environment, e.g., a runtime environment or an operating system environment, that is implemented on one or more client devices such as smart phones, tablet computers, wearable devices, automobile systems, standalone personal assistant devices, or any other appropriate electronic device, and the agent is a virtual agent (also known as “automated assistant” or “mobile assistant”) that may be interacted with by a user through the client devices.

In these cases, the task can be an automated assistance task. That is, the virtual agent can receive instruction data as input from the user (e.g., typed or spoken natural language input) and respond with responsive content (e.g., visual and/or audible natural language output). The virtual agent can perform a broad range of tasks within the execution environment through interactions with various local and/or third-party applications, websites, or other agents.

Examples of the automated assistance tasks include scheduling an appointment through a calendar application, making a phone call through a telephone application, sending an email through an e-mail application, sending an instant message through an instant messaging application, playing a music through a digital music player application, playing a video through a digital video player application, and so on.

The task execution system 100 includes or is in communication with a plurality of tools 105 that can each be used by the task execution system 100. The plurality of tools 105 include one or more generative neural networks 110 and one or more external tools 120. The task execution system 100 also includes a planning engine 130.

The one or more generative neural networks 110 can be either local to, or remote from, the task execution system 100. In some implementations, the one or more generative neural networks 110 include at least an auto-regressive neural network, e.g., a language model neural network or a multi-modal neural network, that is configured to execute an auto-regressive token generation process to auto-regressively generate an output, e.g., a sequence of text tokens, a sequence of pixel tokens, a sequence of audio tokens, a sequence of multi-modal tokens, e.g., text and pixel tokens, or the like, across multiple time steps, for example by generating one token at each time step conditioned on any tokens that have already been generated in previous time steps. Accordingly, the auto-regressive neural network can be configured through training to perform any of a variety of generative tasks, including data, image, video, and audio generation tasks.

Examples of auto-regressive neural networks include those described in Colin Raffel, et al. Exploring the limits of transfer learning with a unified text-to-text transformer. arXiv preprint arXiv:1910.10683, 2019; Daniel Adiwardana, et al. Towards a human-like open-domain chatbot. CoRR, abs/2001.09977, 2020; Aakanksha Chowdhery, et al. PaLM: Scaling Language Modeling with Pathways, arXiv preprint arXiv:2204.02311; Rohan Anil, et al. Palm 2 technical report. arXiv preprint arXiv:2305.10403, 2023; Gemini Team, Gemini: a family of highly capable multimodal models. arXiv preprint arXiv:2312.11805 (2023 ); Zalán Borsos, et al. Audiolm: a language modeling approach to audio generation. IEEE/ACM Transactions on Audio, Speech, and Language Processing (2023); and Andrea Agostinelli, et al. Musiclm: Generating music from text.” arXiv preprint arXiv: 2301.11325 (2023).

In some implementations, the one or more generative neural networks 110 include at least a diffusion model neural network that is configured to execute a reverse diffusion process to iteratively generate an output, e.g., text, an image, a video, or an audio, across multiple reverse diffusion steps starting from random noise.

For example, the diffusion model neural network can generate an image by performing a reverse diffusion process to generate a diffusion output that includes or otherwise specifies a plurality of color values for pixels in the image arranged according to a specified order.

As another example, the diffusion model neural network can generate an image by performing a reverse diffusion process to generate a diffusion output that includes or otherwise specifies a plurality of tokens that represent image patch embeddings of the image which can then be processed by a decoder neural network to generate the image.

Examples of diffusion model neural networks include those described in Chitwan Saharia, et al. Photorealistic text-to-image diffusion models with deep language understanding. Advances in Neural Information Processing Systems, 35:36479-36494, 2022; Aditya Ramesh, et al. Hierarchical text-conditional image generation with clip latents. arXiv preprint arXiv:2204.06125; and Robin Rombach, et al. High-resolution image synthesis with latent diffusion model, Proceedings of the IEEE/CVF conference on computer vision and pattern recognition. 2022.

More generally the task execution system 100 can make use of any appropriate generative neural networks that can be called by the system, e.g., using an API, i.e., that can provide responses to inputs, queries, or prompts provided by the task execution system 100.

The one or more external tools 120 are external to the generative neural networks 110 and, in some implementations, separate, e.g., remote, from the task execution system 100. For example, the external tools 120 can be implemented as computer programs in one or more remote server systems that are separate from the task execution system 100. An external tool 120 can generally be any software that is accessible by the task execution system 100 and that is queryable, e.g., by the task execution system 100 using an API, to provide data in response to a query.

Examples of external tools include a search engine, an optical character recognition (OCR) engine, an object selection engine, a calculator system, a calendar system, a user interface capturing/interacting tool, to name just a few. The search engine can be a general search engine, a topic specific search engine, a scholarly article search engine, an image search engine, an authoritative source search engine (e.g., a search engine that identifies authoritative sources and their respective content), or the like. The object selection engine can implement an object detection model to select an object of interest (e.g., from among a plurality of background objects) in an image, and output an extracted image that includes a depiction of the object of interest.

In some implementations, each of the plurality of tools 105 can be implemented as a service that allows the task execution system 100 to access the functionality of tool 105 over a network, such as the Internet, by use of function calls. For example, each of the plurality of tools 105 can provide an application programming interface (API)—and the task execution system 100 can utilize a function call to the API to initiate execution of the tool 105.

Each function call to a corresponding tool (e.g., a generative neural network or an external tool) includes data to be processed by the corresponding tool. The data can include any data that is included in, or that can otherwise be derived from, the request 102. For example, when the function call is the first function call made by the task execution system 100 after having obtained the request 102, the data to be passed in the function call can include the instruction data, the task data, or both that is included in the request 102, and possibly other data, e.g., system instruction data. As another example, when the function call is a subsequent function call made by the task execution system 100, the data to be passed in the function call can include an output of a previously executed tool that is generated as a return to a previous function call, and possibly other data, e.g., system instruction data.

Optionally, each function call to a corresponding tool includes parameters to utilize in executing the functionality of the corresponding tool. For example, when the corresponding tool is an auto-regressive neural network, the optional parameters can include one or more of: a token sampling parameter (e.g., top-P or top-K parameter), a temperature parameter, and a stopping parameter (e.g., maximum number of output tokens). As another example, when the corresponding tool is a diffusion model neural network, the optional parameters can include one or more of: a step parameter (e.g., maximum number of multiple reverse diffusion steps to be executed), a noise strength parameter (e.g., level of the random noise), or a guidance scale parameter.

In response to a function call, a tool processes the data passed in the function call in accordance with the parameters (when included) to generate an output as a return to the function call. The output can represent either the final result 126 for the task, or an intermediate result for the task, e.g., a partial or otherwise incomplete result for the task.

For example, when the tool is an auto-regressive neural network, the output can include a sequence of text tokens, a sequence of pixel tokens, a sequence of audio tokens, a sequence of multi-modal tokens, e.g., text and pixel tokens, or the like. Analogously, when the tool is a diffusion model neural network, the output can include text, an image, a video, or an audio.

In some cases, the output can represent the final result 126 for the task. For example, the output can include a complete response to a question specified in the request 102 (when the task is a visual question answering task) or a complete video that includes video frames that show a depiction of all of the motions of an object specified in the request 102 (when the task is a video generation task).

In other cases, the output can represent an intermediate result for the task, e.g., a partial or incomplete response to a question specified in the request 102 (when the task is a visual question answering task) or an incomplete video that includes video frames that show a depiction of some but fewer than all of the motions of an object specified in the request 102 (when the task is a video generation task).

As another example, when the tool is an optical character recognition (OCR) engine, the output can include OCR text extracted from an image that is included as part of, or otherwise identified by, the data included in the function call. As yet another example, when the tool is a search engine, the output can include search results that reference resources identified by the search engine. Like the auto-regressive or diffusion model neural network, in some cases, the output represents the final result 126 for the task, whereas, in other cases, the output represents an intermediate result for the task.

To perform the task characterized in the request 102, the planning engine 130 is configured to perform a look ahead search to search through a space of possible combinations of function calls to one or more of the plurality of tools 105. In particular, the space of possible combinations of function calls to one or more of the plurality of tools can be represented as a tree 132 (also referred to as an “experience tree 132”), and the planning engine 130 is configured to perform a look ahead tree search. For example, the look ahead tree search can be a Monte Carlo tree search.

While the space of possible combinations of function calls to one or more of the plurality of tools is logically described as a tree, such a space can be represented by any of a variety of appropriate data structures, e.g., as multiple triples or as an adjacency list, and the planning engine 130 can be configured to use any of a variety of appropriate traversal techniques to perform a look ahead search through the data structure.

The tree 132 includes a plurality of nodes that each represent a function call to a tool and, in some implementations, an output that is generated by the tool as a return to the function call. The tree 132 also includes directed edges that connect the plurality of nodes in the tree 132. An outgoing edge from a first node to a second node in the tree 132 represents providing the output that is generated by a first tool represented by the first node, as part of a second function call to a second tool represented by the second node.

The look ahead tree search includes a plurality of planning iterations. By repeatedly performing the plurality of planning iterations as part of the look ahead tree search, the planning engine 130 searches through the tree 132 having nodes that represent function calls to the plurality of tools 105.

Each planning iteration starts from a root node that, in some implementations, represents a null function call, and continues until reaching a node that satisfies one or more termination criteria. The node that satisfies one or more termination criteria can be a leaf node representing a function call to a tool which returns an output that represents the final result 126 for the task. The node that satisfies one or more termination criteria can also be a leaf node representing an output that does not represent the final result 126 for the task, and that does not contain sufficient information from which the final result 126 for the task can be generated. In this manner, each planning iteration generates a path through the tree 132 that begins with the root node of the tree and ends with a leaf node of the tree.

The planning engine 130 maintains node feature data that includes a success rate for each node in the plurality of nodes in the tree 132. In particular, each node included in the tree 132 is associated with a success rate of a function call to a tool represented by the node when executed (as one of the two or more function calls) to perform the task.

A success rate of a function call reflects the effectiveness of the function call represented by the node in contributing to the generation of the final result 126 (which may or may not be the desired, e.g., correct, result for the task) across the plurality of planning iterations.

In some implementations, for each node included in the tree 132, the success rate associated with the node is determined based on comparing (i) a total count of times the final result 126 is generated when the function call to the tool represented by the node is executed (as one of the two or more function calls) to perform the task during the plurality of planning iterations included in the look ahead tree search to (ii) a total count of times the node is selected during the plurality of planning iterations included in the look ahead tree search. For example, the success rate can be determined as a ratio between (i) and (ii).

In some implementations, the planning engine 130 uses one or more neural networks to guide the look ahead tree search. For example, the neural networks can each be a respective one of the generative neural networks 110 mentioned above, or a different neural network. By using the one or more neural networks to guide the look ahead tree search, the effectiveness of the look ahead tree search can be increased, and a plan 134 that can increase the performance of the task execution system 100 on the task can be generated over fewer planning iterations, using fewer computational resources, and in reduced wall clock time.

At each planning iteration during the look ahead tree search, the planning engine 130 can provide a neural network input, which includes an output generated by a tool as the return to a function call to the tool, to the neural network, and receive back from the neural network a neural network output.

For example, the neural network output can be a classification output that classifies the output generated by the tool either as an intermediate result for the task, or alternatively as a final result 126 for the task. As another example, the neural network output can be a classification output that classifies the output generated by the tool either as an output that does not contain sufficient information based on which the final result 126 for the task can be generated, or alternatively as an output that contains sufficient information, i.e., as an output that can be further expanded or otherwise refined to generate the final result 126.

In these examples, the planning engine 130 can use the neural network outputs to determine whether a node representing the function call to the tool satisfies the one or more termination criteria. Stated differently, the planning engine 130 can use the neural network output to determine whether a current planning iteration is completed or can continue.

Additionally or alternatively, at each planning iteration during the look ahead tree search, the planning engine 130 can provide a neural network input, which includes the request 102 or data derived from the request 102 (e.g., an output of a previously executed tool) or both and an identifier (e.g., a textual identifier or another identifier) of each of one or more tools represented respectively by one or more child nodes of an in-tree node, to the neural network, and receive back from the neural network a neural network output that includes a score assigned to each of the one or more child nodes that indicates a reward with respect to using the tool represented by the child node. For example, the reward can indicate an applicability or benefit of using the tool.

Correspondingly, the planning engine 130 can use the neural network output to determine which child node of one or more child nodes of an in-tree node should be selected for inclusion in the path being generated in the planning iteration, e.g., by selecting the child node representing a tool that has the highest reward from among the one or more tools.

In other implementations where the neural networks are not used during the look ahead tree search, the planning engine 130 can randomly select the nodes for inclusion in the path being generated in each planning iteration, for example.

As a result of the look ahead tree search, the planning engine 130 generates a plan 134 for performing the task characterized in the request 102. That is, the planning engine 130 can generate the plan 134 after the last planning iteration in the plurality of planning iterations. The plan 134 specifies a sequence of two or more function calls. The sequence of function calls can include a first function call followed by a second function call.

In some cases, the sequence of function calls can include function calls to different ones of the plurality of tools 105. For example, the sequence of function calls can include a first function call to an external tool, e.g., an optical character recognition (OCR) engine, followed by a second function call to a generative neural network, e.g., a language model neural network. As another example, the sequence of function calls can include a first function call to a generative neural network, e.g., a language model neural network, followed by a second function call to another generative neural network, e.g., a diffusion model neural network.

In other cases, the sequence of function calls can include multiple function calls to the same one(s) of the plurality of tools 105. For example, the sequence of function calls can include a first function call to a generative neural network, e.g., a language model neural network, followed by a second function call to the same generative neural network, e.g., the same language model neural network. Optionally the first function call and the second function call are separated by one or more intervening function calls to other tools 105.

Having executed the sequence of one or more function calls in accordance with the plan 134, where the last function call in the sequence returns an output that represents the final result 126, the task execution system 100 can then provide the result 126 as an output, e.g., by providing the result 126 to be presented on a display of a client device to the user who submitted the instruction data for the task. Additionally or alternatively, after generating the result 126, the task execution system 100 can provide the result 126 to one or more external systems for storage or further processing.

In some implementations, data representing the tree 132, which is searched through by the planning engine 130 across the plurality of planning iterations as part of the look ahead tree search to generate the plan 134 for the task characterized in the request 102, as well as the node feature data, is stored in a short-term memory of the task execution system 100. In these implementations, once the final result 126 for the task has been generated, the tree 132 as well as the node feature data can be deleted from the short-term memory.

In other implementations, the task execution system 100 includes a long-term memory 140. The long-term memory 140 stores trees as well as the node feature data that have been previously generated by the task execution system 100. The long-term memory 140 (and analogously, the short-term memory) can be any available memory, e.g., one or more physical or logical storage devices, for storing the trees.

For example, the long-term memory 140 can store trees 132 as well as the node feature data that have been generated as part of generating plans for performing historic tasks by the task execution system 100 in response to historic requests 102 received by the task execution system 100 in the past. As another example, the long-term memory 140 can store trees 132 as well as the node feature data that have been generated during the training phase of the task execution system 100, i.e., in response to requests 102 for tasks defined in the training data.

In these implementations, prior to the commencement of the look ahead tree search, i.e., prior to the first planning iteration in the plurality of planning iterations, the planning engine 130 can generate a combined tree based on one or more of the trees as well as the node feature data stored in the long-term memory 140. Then, the planning engine 130 searches through the combined tree across the plurality of planning iterations as part of the look ahead tree search to generate the plan 134 for the task characterized in the request 102.

In particular, the combined tree will include nodes obtained from each of one or more of the trees stored in the long-term memory 140. For each node in the plurality of nodes included in the combined tree, the success rate associated with each node in the tree can represent a historic success rate of a function call to a tool represented by the node when executed to perform each of one or more historic tasks that are similar to the task characterized in the request 102.

In some implementations, the task execution system 100 can determine which historical tasks are similar to the task characterized in the received request 102 through keyword matching, i.e., identifying historical tasks the requests for which contain certain words or terms (keywords) that are also included in the received request 102, or using more sophisticated techniques, e.g., by providing the requests for historical tasks and the received request 102 as input to a generative neural network 110 and receive back from the generative neural network a neural network output that identifies which historical tasks have requests that are similar to the received request 102.

For example, when the task characterized in the request 102 is a visual question answering task, the task execution system 100 can generate the combined tree based on trees generated as part of generating plans for performing one or more historic visual question answering tasks that involve different visual inputs (e.g., different images or different videos), different text, or both.

As another example, when the task characterized in the request 102 is a particular automated assistance task, e.g., a task involving scheduling an appointment through a calendar application, the task execution system 100 can generate the combined tree based on trees generated as part of generating plans for performing one or more historic automated assistance tasks, e.g., tasks involving making a phone call through a telephone application, sending an email through an e-mail application, sending an instant message through an instant messaging application, and so forth.

The information contained in the trees and the node feature data stored in the long-term memory 140 makes possible to increase the effectiveness of the look ahead tree search. By performing a look ahead tree search through the combined tree, a plan 134 that can increase the performance of the task execution system 100 on the task can be generated over fewer planning iterations, using fewer computational resources, and in reduced wall clock time. Moreover, the information contained in the trees stored in the long-term memory 140 improves the continuous learning capability of the task execution system 100 to enable it to continuously integrate different function calls for different tasks into the search space, and to generalize quickly to unseen, new tasks characterized in new requests.

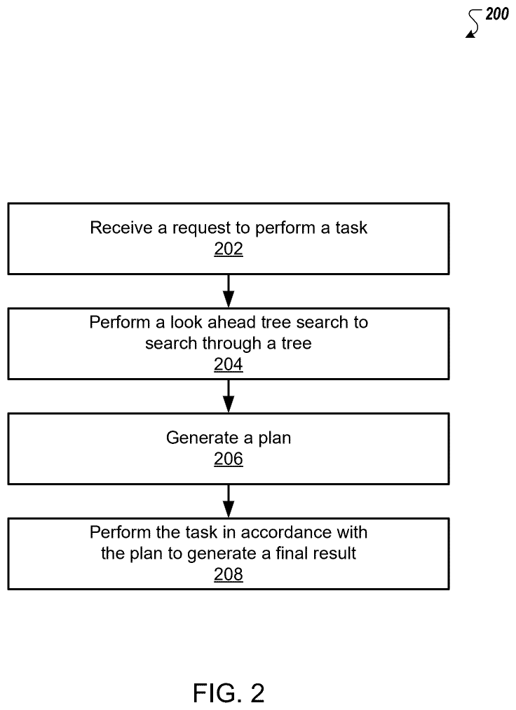

FIG. 2 is a flow diagram of an example process 200 for performing a task using a plurality of tools. The plurality of tools include one or more generative neural networks and one or more external tools. For convenience, the process 200 will be described as being performed by a system of one or more computers located in one or more locations. For example, a task execution system, e.g., the task execution system 100 of FIG. 1, appropriately programmed, can perform the process 200.

The system receives a request to perform the task (step 202). As mentioned above, the request can include instruction data that characterizes the task to be performed by the system and context data that will be processed by the system in order to perform the task. In some implementations, process 200 is performed by a virtual agent that may be interacted with by a user through a client device, and the request to perform the task is received as part of an input provided by the user to the client device. For example, the input can be in the form of a prompt that includes natural language text.

The system performs a look ahead tree search to search through a tree (step 204). The tree includes a plurality of nodes. Each node represents a function call to a tool and, in some implementations, an output that is generated by the tool as a return to the function call. In this manner, the tree represents a space of possible combinations of function calls to one or more of the plurality of tools.

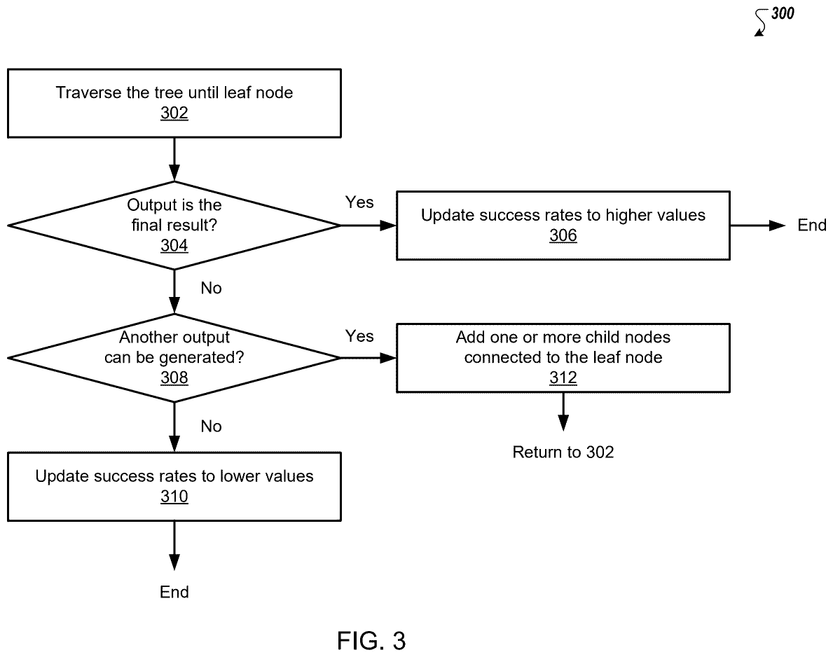

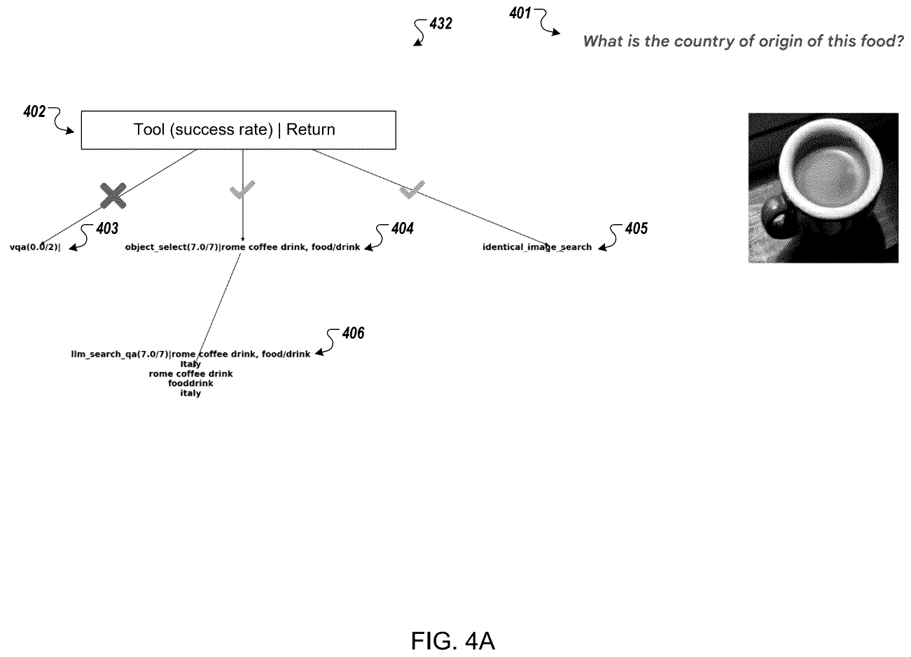

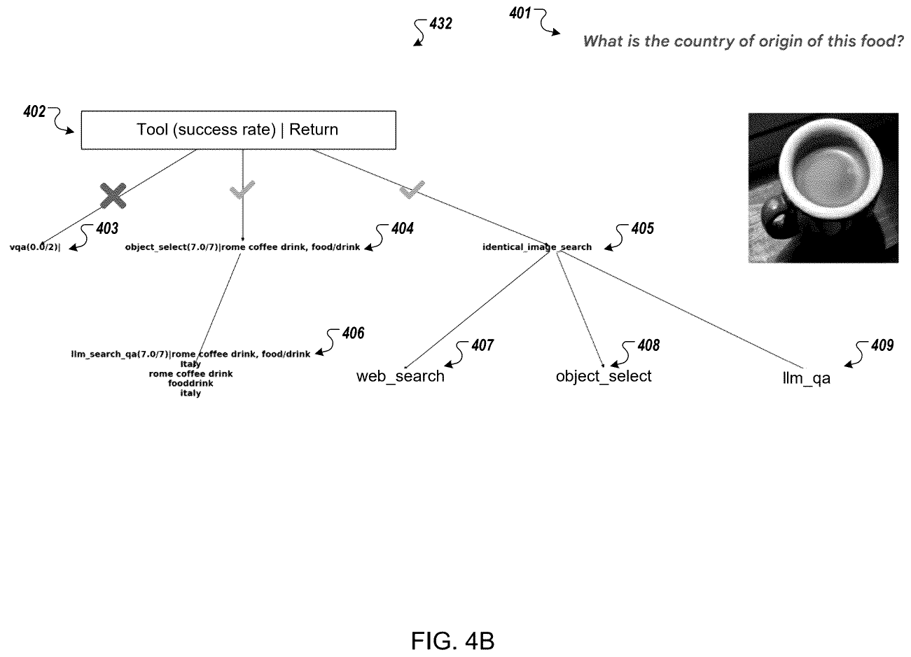

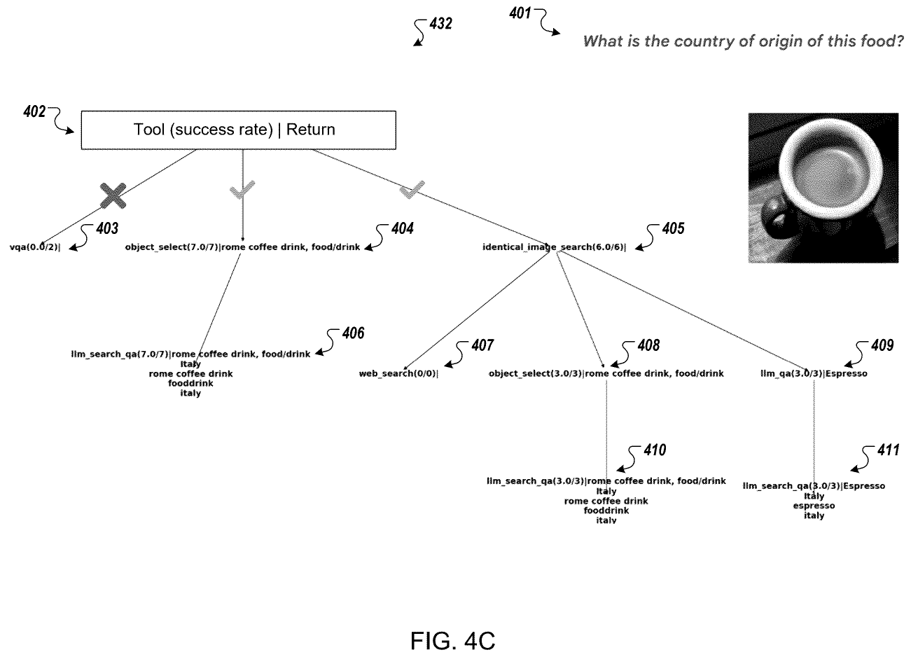

The look ahead tree search includes a plurality of planning iterations. Performing a planning iteration will be described in more detail with reference to FIGS. 3-4. Each planning iteration generates a path through the tree that begins with the root node of the tree and ends with a leaf node of the tree. Generally, different planning iterations generate different paths through the tree, e.g., begins with the same root node of the tree and ends with a different leaf node of the tree, although in some cases two or more planning iterations may generate the same path.

Each path includes a proper subset of the plurality of nodes which are arranged one after another in an order along the path through the tree. The proper subset of the plurality of nodes includes the root node of the tree and a leaf node of the tree. For example, the proper subset of the plurality of nodes can include a first node that represents a first function call and a second node that represents a second function call, where the first node is connected by an outgoing edge to the second node, indicating that the first function call should be executed prior to the second function call.

As a result of the look ahead tree search, the system generates a plan for performing the task characterized in the request (206). To do so, the system selects, as a selected path, one of the plurality of paths that have been generated across the plurality of planning iterations, and then generates the plan based on the proper subset of the plurality of nodes included in the selected path. The path can be selected from the plurality of paths in any of a variety of ways, as will be described in more detail with reference to FIG. 3 and FIGS. 4A-C.

Correspondingly, the plan specifies a sequence of two or more function calls which are represented by the proper subset of the plurality of nodes included in the selected path. For example, the sequence of function calls specified by the plan can include a first function call represented by a first node included in the selected path, followed by a second function call represented by a second node included in the selected path, where the first node is connected by an outgoing edge to the second node in the selected path.

In some implementations, the system provides the plan for presentation to the user, e.g., within a user interface displayed on the client device through which the user provided the input, as a response to the request. In some implementations, leveraging the user interface, the system allows the user to edit the plan, initiate the execution of the plan, and, while executing the plan, showing to the user as it executes the plan, e.g., at what stage of the plan is the execution. In some implementations, the system allows the user to pause or stop the execution of the plan. Since the plan can be represented as a tree that includes nodes and edges connecting the nodes, the system makes it easier for the user to decide whether and when to stop or pause the execution of the plan. The system can thus reduce computational resource usage when execution is stopped early.

The system performs the task to generate a final result in accordance with the plan (step 208). That is, the system performs the task based on executing the sequence of two or more function calls which are represented by the proper subset of the plurality of nodes included in the selected path, where the last function call in the sequence returns an output that represents the final result.

In particular, the sequence of two or more function calls are executed by the system in accordance with the order of the proper subset of the plurality of nodes along the selected path. Thus, for example, performing the task can involve executing the first function call represented by the first node included in the selected path and, after having executed the first function call, executing the second function call represented by the second node included in the selected path. In some implementations, performing the task excludes, i.e., does not involve, executing any function call that is not represented by a node included in the selected path.

In some implementations, the system parallelizes the two or more function calls represented by different nodes in the tree, e.g., such that a first function call is executed in parallel with a second function call. Parallelized function calls can decrease the overall time needed for generating the final result in accordance with the plan. Represented as a tree, the plan readily identifies any aspects of the plan that can be performed in parallel. For example, two or more function calls can be parallelized if the function calls are represented by nodes that do not depend on each other, e.g., the leaf nodes in the tree.

FIG. 3 is a flow diagram of an example process 300 for performing a planning iteration. For convenience, the process 300 will be described as being performed by a system of one or more computers located in one or more locations. For example, a task execution system, e.g., the task execution system 100 of FIG. 1, appropriately programmed, can perform the process 300.

FIG. 3 is described in conjunction with FIGS. 4A-C, which show example illustrations of a tree 432 that can be maintained by a task execution system, e.g., the task execution system 100 of FIG. 1, when performing the task using the plurality of tools.

The system traverses the tree starting from a root node of tree until reaching a leaf node of tree (step 302). In some implementations, the root node represents a null function call.

In the example of FIG. 4A, the request 401 received by the system is: “What country does this place belong to? [image]” where “What country does this place belong to?” is in the form of textual data represents the instruction data that characterizes a task and “[image]” is in the form of image data represents the context data. In other words, the task is a visual question answering task. The visual question answering task in this example is a multi-modal task because it requires processing by the system both the instruction data is in the form of textual data and the context data is in the form of image data.

Specifically, at each in-tree node, i.e., a node encountered starting from (and including) the root node until reaching the leaf node, the system selects, from among one or more child nodes of the in-tree node that are connected to the in-tree node by respective outgoing edges that point away from the in-tree node, a selected child node. The selected child node is then included in the same path being generated in the planning iteration as the in-tree node. The system continues traversing the tree in this manner until a leaf node in the tree is reached. Generally, a leaf node is a node in the tree that has no child nodes, i.e., is not connected to any other nodes by an outgoing edge.

There are many ways in which the system can make this selection. In some implementations, the system can randomly sample a node from among the one or more child nodes of the in-tree node, or use a fixed node selection scheme to select the node. For example, the selection can be based on visit counts or other statistics for the nodes in the tree.

In some implementations, the system can use a neural network to select the child node for inclusion in the same path as the in-tree node. As mentioned above, the system can provide a neural network input, which includes the request or data derived from the request (e.g., an output of a previously executed tool) or both and an identifier (e.g., a textual identifier or another identifier) of each of one or more tools represented respectively by the one or more child nodes of the in-tree node, to the neural network, and receive back from the neural network a neural network output that includes a score assigned to each of the one or more child nodes of the in-tree node. For each child node, the score indicates a reward with respect to using the tool represented by the child node. For example, the reward can indicate an applicability or benefit of using the tool.

In these implementations, the system can use the neural network output to determine which child node of one or more child nodes of the in-tree node should be selected for inclusion in the path being generated in the planning iteration. For example, the system can select the child node representing a tool that has the highest reward from among the one or more tools. As another example, the system can sample a tool from among the one or more tools in accordance with a probability distribution that includes a probability score assigned to each tool that is dependent on, e.g., proportional to, the reward for the tool, and then use the child node representing the sampled tool as the selected tool.

In some implementations, the system can use the success rates associated with the plurality of nodes included in the tree to select the child node for inclusion in the same path as the in-tree node. For example, the system can select the child node representing a tool that has the highest success rate from among the one or more tools. As another example, the system can sample a child node from among the one or more child nodes in accordance with a probability distribution that includes a probability score assigned to each child node that is dependent on, e.g., proportional to, the success rate associated with the child node.

In some implementations where the tree is a combined tree generated based on one or more of the trees as well as the node feature data stored in the long-term memory, the system makes this selection based on the existing success rates that have been determined as a result of the historical look ahead tree searches for the historical tasks that are similar to the task.

As illustrated in FIG. 4A, at a planning iteration, the system can traverse the tree 432 starting from the root node 402 of tree 432 until reaching a leaf node 406 of tree 432. The leaf node 406 represents a function call to a tool that is a generative neural network. The function call can include an image of an object that is included in an output generated as a return to a function call to a tool (an object selection engine) represented by the parent node 404 of the leaf node 406. When initiated, the generative neural network executes the function call to generate an output as a return to the function call that includes the final result “Rome, Italy” for the visual question answering task.

The system then proceeds to perform step 304 and, in some cases, step 308 to evaluate the leaf node of the tree encountered during the planning iteration.

The system determines whether an output generated as a return to a function call represented by the leaf node is the final result (step 304). There are many ways in which the system can make this determination.

In some implementations, the system can use a rule, a deterministic algorithm, or a model to process the output to determine whether the output is the final result. For example, the system can apply a set of task-specific rules that establish the criteria for progression and termination of the task to the output to determine whether the output is the final result.

In some implementations, the system can use a neural network to make this decision. As mentioned above, the system can provide a neural network input, which includes an output generated by a tool as the return to a function call to the tool, to the neural network, and receive back from the neural network a neural network output, which is a classification output that classifies the output generated by the tool either as an intermediate result for the task, or alternatively as a final result for the task.

In response to determining that the output generated as the return to the function call represented by the leaf node is the final result, the process 300 proceeds from step 304 to step 306. Alternatively, in response to determining that the output generated as the return to the function call represented by the leaf node is not the final result, i.e., it is an intermediate result, the process 300 proceeds from step 304 to step 308.

The system updates the success rate associated with each node included along the same path as the leaf node that is being generated in the planning iteration (step 306). Since the output generated as the return to the function call represented by the leaf node is the final result, in some cases, the success rates associated with the nodes can be updated to have greater values.

In some implementations where the success rates are determined as the ratio as mentioned above, the system can increase (e.g., increment by one) (i) the total count of times a final result is generated when the tools represented by the nodes included in the path are used to perform the task during the look ahead tree search, and also increase (e.g., increment by one) (ii) the total count of times the path is generated during the look ahead tree search for the task.

In some implementations where the tree is a combined tree generated based on one or more of the trees as well as the node feature data stored in the long-term memory, the system updates the success rate associated with the nodes starting from their existing success rates.

For example, the system can update the success rates starting from (i) the total count of times a final result is generated when the tools represented by the nodes included in the path are used to perform the historical tasks that are similar to the task during the historical look ahead tree searches, and (ii) a total count of times the path is generated during the historical look ahead tree searches for the historical tasks that are similar to the task.

As illustrated in FIG. 4A, since the output generated as the return to the function call represented by the leaf node 406 is the final result “Rome, Italy” for the visual question answering task, the success rates associated with the nodes included along the path that includes node 404, and node 406 can be updated to have greater values. For example, both the numerator term and the denominator term used to compute the ratio for each of node 404 and node 406 can be incremented by one, leading to a higher success rate.

After step 306, the process 300 ends. That is, the planning iteration stops, and a path through the tree that has been traversed so far by performing the process 300 is returned as the path that has been generated in the planning iteration.

The system determines whether another output can be generated based on the output generated as the return to the function call represented by the leaf node (step 308). There are many ways in which the system can make this determination.

In some implementations, the system can use a rule, a deterministic algorithm, or a model to process the output to determine whether another output can be generated based on the output. For example, the system can apply a set of task-specific rules that establish the criteria for progression and termination of the task to the output to determine whether another output can be generated based on the output.

In some implementations, the system can use a neural network to make this decision. As mentioned above, the system can provide a neural network input, which includes an output generated by a tool as the return to a function call to the tool, to the neural network, and receive back from the neural network a neural network output, which is a classification output that classifies the output generated by the tool either as an output that does not contain sufficient information from which the final result for the task can be generated, or alternatively as an output that contains sufficient information from which the final result for the task can be generated.

In response to determining that the output generated as the return to the function call represented by the leaf node is not the final result, and that another output cannot be generated based on the output (e.g., because the output does not contain sufficient information), the process 300 proceeds from step 308 to step 310. Alternatively, in response to determining that the output generated as the return to the function call represented by the leaf node is not the final result, and that another output can be generated based on the output (e.g., because the output contains sufficient information), the process 300 proceeds from step 308 to step 312.

As illustrated in FIG. 4A, at a planning iteration, the system can traverse the tree 432 starting from the root node 402 of tree 432 until reaching a leaf node 405 of tree 432. The leaf node 405 represents a function call to a tool that is an identical image search tool. The function call can include the [image] included in the request 401 received by the system. When initiated, the identical image search engine executes the function call to generate an output as a return to the function call that includes search results that reference images identified by the identical image search engine as identical or substantively similar to [image].

Then, as illustrated in FIG. 4B, at the planning iteration, the system determines whether the output generated as the return to the function call represented by the leaf node 405 is the final result, and, since the output is not the final result, also determines whether another output can be generated based on the output generated as the return to the function call represented by the leaf node 405. In FIG. 4B, the system determines that another output can be generated based on the output.

The system updates success rates associated with nodes arranged along a same path as the leaf node to have smaller values (step 310). Since the output generated as the return to the function call represented by the leaf node is not the final result, and that another output cannot be generated based on the output, the success rates associated with the nodes can be updated to have smaller values.

In some implementations where the success rates are determined as the ratio as mentioned above, the system can increase (e.g., increment by one) the total count of times the path is generated during the look ahead tree search for the task, while withholding from increasing the total count of times a final result is generated when the tools represented by the nodes included in the path are used to perform the task during the look ahead tree search.

As illustrated in FIG. 4A, at a planning iteration, the system can traverse the tree 432 starting from the root node 402 of tree 432 until reaching a leaf node 403 of tree 432. The leaf node 403 represents a function call to a tool that is a generative neural network. The function call can include the [image] included in the request 401 received by the system. When initiated, the generative neural network executes the function call to generate an output as a return to the function call.

Then, at the planning iteration, the system determines whether the output generated as the return to the function call represented by the leaf node 403 is the final result, and, since the output is not the final result, also determines whether another output can be generated based on the output generated as the return to the function call represented by the leaf node 403.

In FIG. 4A, the system determines that another output cannot be generated based on the output. Correspondingly, the success rates associated with the node 403 can be updated to have smaller values. For example, only the denominator term used to compute the ratio for the node 403 can be incremented by one, while the numerator term used to compute the ratio for the node 403 is not changed, leading to a lower success rate.

After step 310, the process 300 ends. That is, the planning iteration stops, and a path through the tree that has been traversed so far by performing the process 300 is returned as the path that has been generated in the planning iteration.

The system expands the leaf node (step 312). That is, the system adds, to the tree, one or more child nodes that are each connected to the leaf node by respective outgoing edges that point away from the leaf node. Each child node represents another function call to a respective one of one or more of the plurality of tools to be executed after having executed the function call represented by the leaf tool. In some implementations, the system adds, to the tree, one child node for every possible tool.

As illustrated in FIG. 4B, after reaching and evaluating the leaf node 405 of tree 432 at the planning iteration, the system expands the node 405, i.e., adds three child nodes 407, 408, 409 of the node 405 to the tree 432. The three child nodes 407, 408, 409 represent a general search engine, an object selection engine, and a generative neural network, respectively, that can each be used to process the output (generated as the return to the function call represented by the node 405) to generate another output, when performing the visual question answering task.

From step 312, the process 300 returns from step 312 to step 302. That is, the system continues to traverse the tree to add one of the one or more added child nodes of the leaf node for inclusion in the path being generated in the planning iteration.

By repeatedly performing iterations of the process 300, the system can perform the look ahead tree search that includes a plurality of planning iterations to search through the tree representing the space of possible combinations of function calls to one or more of the plurality of tools. Each planning iteration generates a path through the tree that begins with the root node of the tree and ends with a leaf node of the tree.

Then, the system can select, as a selected path, one of a subset of the plurality of paths that have been generated as a result of the look ahead tree search and that each include a leaf node that represents a function call that has a return representing the final result for the task.

For example, in FIG. 4C, the system can select from a total of 4 paths (a path that ends with leaf node 406, a path that ends with leaf node 407, a path that ends with leaf node 410, and a path that ends with leaf node 411). Notably, in FIG. 4C, the system refrains from selecting the path that ends with leaf node 403 (because the return to the function call represented by the leaf node 403 is not the final result).

In some implementations, the system can select the shortest path, i.e., the path that includes the least number of nodes, from among the subset of the plurality of paths. Since each node represents a function call, in doing so the system can conserve the total amount of computational resources required to execute the function calls when performing the task.

In some implementations, the system can further evaluate the quality of the final result included in the return of the function call represented by each of the leaf nodes 406, 407, 410, 411, and select a path that includes a leaf node representing a function call the return of which has the highest quality among all function call returns. For example, the quality can be evaluated using a timeliness metric, a responsiveness metric, a helpfulness metric, a comprehensiveness metric, a conciseness metric, a correctness/accuracy metric, or some combination of these metrics, and possibly other metrics.

Suppose, in the example of FIG. 4C, that the system selects the path that includes node 404 and node 406. Then, to perform the task in accordance with the plan, the system executes a first function call to an object selection engine and, after having executed the first function call, executes a second function call to a generative neural network, where the return to the second function call includes the final result.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by an agent for performing a task, the method comprising:
receiving, by the agent, an input in a form of a prompt that comprises a request to perform the task;
performing, by the agent, a look ahead tree search to generate a selected path through a tree that comprises a plurality of nodes each representing a function call to a tool, wherein the selected path comprises a subset of the plurality of nodes arranged in an order along the selected path; and
performing, by the agent, the task to generate a final result based on executing function calls to respective tools represented by the subset of the plurality of nodes in accordance with the order of the subset of the plurality of nodes along the selected path.

2. The method of claim 1, wherein each node in the plurality of nodes represents a function call to one of: a generative neural network or an external tool.

3. The method of claim 1, wherein performing the look ahead tree search to generate the selected path through the tree comprises:
performing the look ahead tree search to generate a plurality of paths through the tree, wherein each path begins with a same root node of the tree and ends with a different leaf node of the tree; and
selecting, as the selected path, one of the plurality of paths.

4. The method of claim 3, wherein each node in the plurality of nodes is associated with a success rate of a function call to a tool represented by the node when executed to perform the task, and wherein selecting, as the selected path, one of the plurality of paths comprises:
selecting one of the plurality of paths based on success rates associated with the plurality of tools.

5. The method of claim 4, wherein for each node in the plurality of nodes, the success rate associated with the node is determined based on a ratio of (i) a total count of times a candidate final result is generated when the function call to the tool represented by the node is executed to perform the task during the look ahead tree search to (ii) a total count of times the node is selected during the look ahead tree search.

6. The method of claim 1, wherein performing the look ahead tree search comprises evaluating leaf nodes of the tree encountered during the look ahead tree search using a neural network.

7. The method of claim 6, wherein evaluating leaf nodes of the tree encountered during the look ahead tree search comprises:
determining, using the neural network, whether an output generated as a return to a function call represented by a leaf node is the final result.

8. The method of claim 7, further comprising, in response to determining that the output generated as the return to the function call represented by the leaf node is the final result:
updating success rates associated with nodes included along a same path as the leaf node to have greater values.

9. The method of claim 7, further comprising, in response to determining that the output generated as the return to the function call represented by the leaf node is not the final result:
determining, using the generative neural network, whether another output can be generated based on the output generated as the return to the function call represented by the leaf node.

10. The method of claim 9, further comprising, in response to determining that the output generated as the return to the function call represented by the leaf node is not the final result, and that another output can be generated based on the output:
adding, to the tree, one or more child nodes that are each connected to the leaf node by an edge, wherein each child node represents another function call to a tool to be executed after the function call represented by the leaf tool.

11. The method of claim 9, further comprising, in response to determining that the output generated as the return to the function call represented by the leaf node is not the final result, and that another output cannot be generated based on the output:
updating success rates associated with nodes arranged along a same path as the leaf node to have smaller values.

12. The method of claim 1, wherein performing the look ahead tree search comprises, for a parent node of the tree encountered during the look ahead tree search:
selecting, from among a plurality of child nodes of the parent node, a selected child node to be included along a same path as the parent node using the neural network.

13. The method of claim 1, wherein performing the look ahead tree search comprises, for a parent node of the tree encountered during the look ahead tree search:
selecting, from among a plurality of child nodes of the parent node, a selected child node to be included along a same path as the parent node based on success rates associated with the nodes.

14. The method of claim 1, wherein the task comprises a multi-modal task, and wherein the generative neural network comprises a multi-modal generative neural network.

15. The method of claim 14, wherein the multi-modal task comprises a visual question answering task.

16. A system comprising:
one or more computers; and
one or more storage devices storing instructions that, when executed by the one or more computers, cause the one or more computers to perform operations comprising:
receiving, by an agent, an input in a form of a prompt that comprises a request to perform the task;
performing, by the agent, a look ahead tree search to generate a selected path through a tree that comprises a plurality of nodes each representing a function call to a tool, wherein the selected path comprises a subset of the plurality of nodes arranged in an order along the selected path; and
performing, by the agent, the task to generate a final result based on executing function calls to respective tools represented by the subset of the plurality of nodes in accordance with the order of the subset of the plurality of nodes along the selected path.

17. The system of claim 16, wherein each node in the plurality of nodes represents a function call to one of: a generative neural network or an external tool

18. The system of claim 16, wherein performing the look ahead tree search to generate the selected path through the tree comprises:
performing the look ahead tree search to generate a plurality of paths through the tree, wherein each path begins with a same root node of the tree and ends with a different leaf node of the tree; and
selecting, as the selected path, one of the plurality of paths.

19. The system of claim 18, wherein each node in the plurality of nodes is associated with a success rate of a function call to a tool represented by the node when executed to perform the task, and wherein selecting, as the selected path, one of the plurality of paths comprises:
selecting one of the plurality of paths based on success rates associated with the plurality of tools.

20. One or more non-transitory computer-readable storage media storing instructions that when executed by one or more computers cause the one or more computers to perform operations comprising:
receiving, by an agent, an input in a form of a prompt that comprises, a request to perform the task;
performing, by the agent, a look ahead tree search to generate a selected path through a tree that comprises a plurality of nodes each representing a function call to a tool, wherein the selected path comprises a subset of the plurality of nodes arranged in an order along the selected path; and
performing, by the agent, the task to generate a final result based on executing function calls to respective tools represented by the subset of the plurality of nodes in accordance with the order of the subset of the plurality of nodes along the selected path.
